(19) United States
(12) Patent Application Publication
(10) Pub. No.: US 2022/0300003 A1
(43) Pub. Date: Sep. 22, 2022

(54) AUTONOMOUS WORK DEVICE

(71) Applicant: HONDA MOTOR CO., LTD., Tokyo (JP)

(72) Inventors: Atsushi SOTOME, Saitama (JP); Takuya KANISAWA, Saitama (JP); Takumi HATADA, Saitama (JP)

(21) Appl. No.: 17/694,898

(22) Filed: Mar. 15, 2022

(30) Foreign Application Priority Data
Mar. 19, 2021 (JP) 2021-045366

(51) Int. Cl. G05D 1/02; G05D 1/00

(52) U.S. Cl. CPC G05D 1/0217; G05D 1/0223; G05D 1/0022; G05D 2201/0208

(57) ABSTRACT

An autonomous lawnmower (1) including a work unit (12), a travel unit (11), a first control unit (20), a state detecting unit (21), and a communication device (30) wherein the first control unit is configured to transmit state information regarding the operating state via the communication device at a prescribed transmission time interval, the prescribed transmission time interval being varied between a first time interval, and a second time interval which is longer than the first time interval based on the operating state.

### TECHNICAL FIELD

The present invention relates to an autonomous work device such as robot mowers.

### BACKGROUND ART

Known are anti-theft devices for mobile bodies that are configured to communicate the occurrence of theft to the outside. See JP3839400B2, for instance. The anti-theft device disclosed in this prior art document is configured to transmit position information and a theft signal to the outside when the difference between the detected position and the prescribed position exceeds a certain threshold.

Also is known a vehicle position reporting device that is capable of wireless communication for the purpose of tracking a stolen vehicle. See JP3687466B2, for instance. The vehicle position reporting device disclosed in this prior art document is configured to transmit a signal containing position information in response to an inquiry signal transmitted from a communication network at a time interval designated by the inquiry signal.

When operating an autonomous work device which travels by itself, it is desirable that the operator is able to know the position of the work device and the operating condition of the work device from a remote location at all times. However, if the work device transmits the position information and the operating condition constantly, the volume of communication and the power consumption of the battery may become unacceptably great.

### SUMMARY OF THE INVENTION

In view of such a problem of the prior art, a primary object of the present invention is to provide an autonomous work device that allows a user to constantly monitor the status of the work device without unacceptably increasing the volume of communication and the power consumption of the battery.

To achieve such an object, the present invention provides a work device (1), comprising: a work unit (12) configured to perform a prescribed work; a travel unit (11) configured to propel the work device; a first control unit (20) configured to control the work unit and the travel unit; a state detecting unit (21) configured to detect an operating state of the work unit and the travel unit; and a communication device (30) configured to transmit state information on the operating state of the work unit and the travel unit, wherein the first control unit is configured to transmit state information regarding the operating state via the communication device at a prescribed transmission time interval, the prescribed transmission time interval being varied between a first time interval, and a second time interval which is longer than the first time interval based on the operating state.

According to this configuration, since the first control unit transmits the state information regarding the operating state of the work device via the communication device, the state of the work device can be confirmed from a remote location. Further, the first control unit varies the time interval of transmitting the state information based on the operating state of the work device so that the volume of communication and power consumption of the battery can be minimized.

Preferably, the first control unit is configured to set the transmission time interval to the second time interval when the operating state is normal, and set the transmission time interval to the first time interval when the operating state is not normal.

When the operating state is normal, and no immediate attention is therefore required, the transmission time interval may be comparatively long so that the volume of communication and the power consumption of the battery may be minimized. When the operating state is not normal, and an immediate attention is therefore required, the transmission time interval may be comparatively short so that the operator can be notified without any excessively delay.

Preferably, the first control unit is configured to set the transmission time interval to a third time interval which is longer than the second time interval when the work unit and the travel unit are not operating.

According to this configuration, when the work device is neither working nor traveling, the transmission time interval may be longer than when the work device is at least working or traveling. When the work device is neither working nor traveling, since there is little need to monitor the status of the work device, it is advantageous to minimize the volume of communication and the power consumption of the battery.

Preferably, the work device further comprises an own position information acquisition unit (22) for acquiring own position information, and the first control unit is configured to transmit the own position information together with the state information via the communication device.

Thereby, the operator can have the own position information of the work device as required.

Preferably, the work device further comprises a first battery (19) for supplying electric power to the work unit and the travel unit, and a second battery (38) for supplying electric power to the communication device.

Thereby, even when the charge of the first battery is spent, the communication device can continue to operate.

Preferably, the work device further comprises a second battery, when the power is turned on, and the first battery has a charge greater than a prescribed threshold, the first battery supplies electric power to the first control unit and the communication device, and when the charge of the first battery has fallen below the threshold, electric power is supplied from the second battery to the second control unit so that the second control unit continues to transmit the own position information and the state information via the communication unit at a prescribed time interval.

Thereby, even if the first battery runs out, the transmission can be continued by the second control unit powered by the second battery and via the communication device.

Preferably, the transmission time interval for transmitting the state information via the communication device is longer when the communication device receives electric power from the second battery than when the communication device receives electric power from the first battery.

When electric power is being received from the second battery, the transmission time interval is lengthened so that the consumption of the second battery can be reduced. Therefore, the transmission can be continued for a longer period of time.

Preferably, when the first control unit has detected the operating state to be not normal, the first control unit ceases supply of electric power from the first battery to the first control unit upon elapsing of a prescribed time period from a time point of detecting the operating state to be not normal.

Thereby, in case of an abnormal operating state, the power consumption of the first battery can be minimized so that the work device is enabled to resume operating as soon as the abnormal state of the work device is eliminated.

Preferably, the first control unit is configured to determine if the work device is located within a control area (29) designated by a user based on the own position information, and upon detecting that the work device is not located within the control area, the transmission time interval is set to a fourth time interval which is longer than the second time interval.

If the work device is not located within the control area, it is possible that the work device has been stolen. In such a case, it is preferable to increase the transmission time interval so that the own position information may be continued to be transmitted for a long period of time to allow a maximum time period for tracking the work device.

Thus, the present invention provides an autonomous work device that allows a user to constantly monitor the status of the work device without unacceptably increasing the volume of communication and the power consumption of the battery.

### BRIEF DESCRIPTION OF THE DRAWING(S)

FIG. 1 is a diagram showing a lawn mowing management system including a lawnmower and a communication network according to an embodiment of the present invention;

FIG. 2 is a side view of the lawnmower according to the present embodiment;

FIG. 3 is a functional block diagram showing the configuration of the lawnmower;

FIG. 4 is a diagram showing a control area and work areas designated by an operator;

FIG. 5 is a flow chart of a process for determining a transmission time interval; and

FIG. 6 is a table showing the dependence of the transmission time interval on the operating state and own position of the lawnmower.

### DESCRIPTION OF THE PREFERRED EMBODIMENT(S)

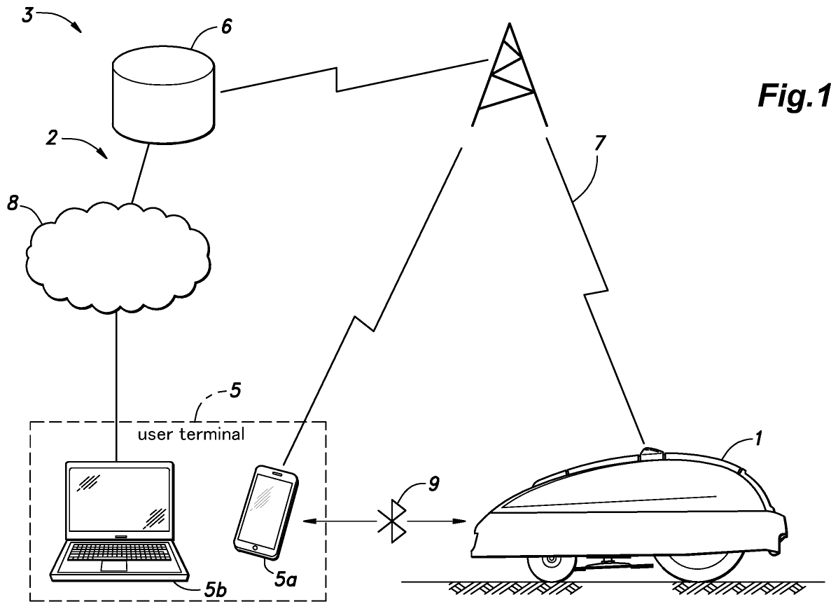

A work device in the form of a lawnmower according to the present invention is described in the following with reference to the appended drawings. FIG. 1 is a diagram showing a lawnmower management system 3 including a lawnmower 1 and a communication network 2 according to the present invention. The lawnmower 1 is configured to autonomously perform lawnmowing work, and the lawnmower management system 3 further includes, a user terminal 5 possessed by a user or an operator of the lawnmower 1, and a server 6. The user terminal 5 may be a smartphone 5a, a PC 5b, or the like. The lawnmower 1 can communicate with the user terminal 5 via a long-distance wireless communication line such as a cellular communication line 7 or the Internet 8 combined with the use of the cellular communication line 7 and the server 6.

The server 6 transmits the information provided by the user via the Internet 8 to the lawnmower 1 via the cellular communication line 7, and transmits the information provided by the lawnmower 1 via the cellular communication line 7 to the user via the Internet 8. Thus, the server 6 allows the user terminal 5 such as a PC 5b which is not connected to the cellular communication line 7 to communicate with the lawnmower 1. Alternatively, the lawnmower 1 may be configured to communicate with the user terminal 5 via a short-range wireless communication 9 such as Bluetooth (registered trademark) and WiFi.

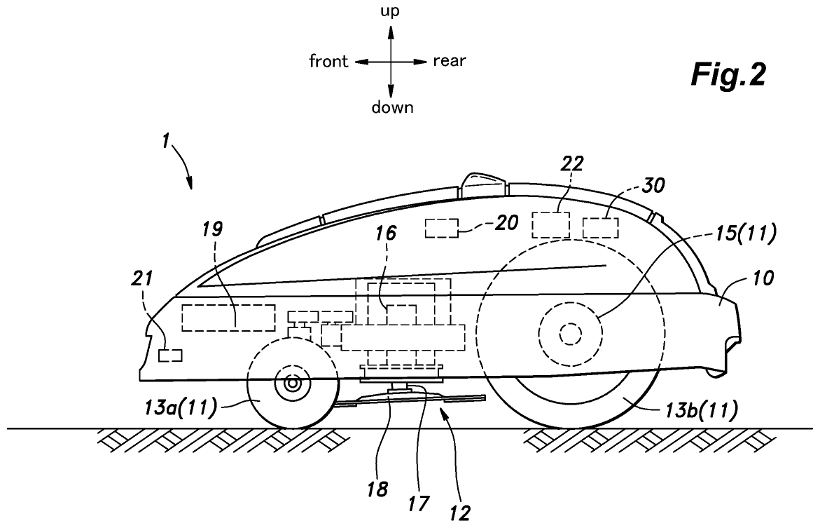

FIG. 2 is a side view of the lawnmower 1 according to the present embodiment. The lawnmower 1 is an autonomous traveling type lawnmower that can autonomously travel to mow grass. The lawnmower 1 includes a main body 10, a travel unit 11 provided in the main body 10 for propelling the lawnmower 1, and a work unit 12 provided centrally in a lower part of the main body 10.

The travel unit 11 has a pair of front wheels 13a, and a pair of rear wheels 13b, and a pair of travel motors 15 that individually drive the left and right rear wheels 13b. Thus, the lawnmower 1 is able to travel forward or backward by driving the left and right travel motors 15 in a forward or backward direction at an equal rotational speed, and turn in a desired direction by driving the left and right travel motors 15 at different speeds.

The work unit 12 includes a work motor 16 (electric motor) and a lawn mowing cutting blade 18 attached to the lower end of a rotary shaft 17 of the work motor 16 to be driven by the work motor 16. The work unit 12 is thus configured to perform lawnmowing work by rotationally driving the cutting blade 18 by the work motor 16.

Further, the lawnmower 1 is provided with a first battery 19 serving as a main battery for supplying electric power to the travel unit 11 and the work unit 12, a first control unit 20 for controlling the travel unit 11 and the work unit 12, a state detection unit 21 for detecting the operating state of the travel unit 11 and the work unit 12, and an own position information acquisition unit 22 for acquiring the position information of the lawnmower 1.

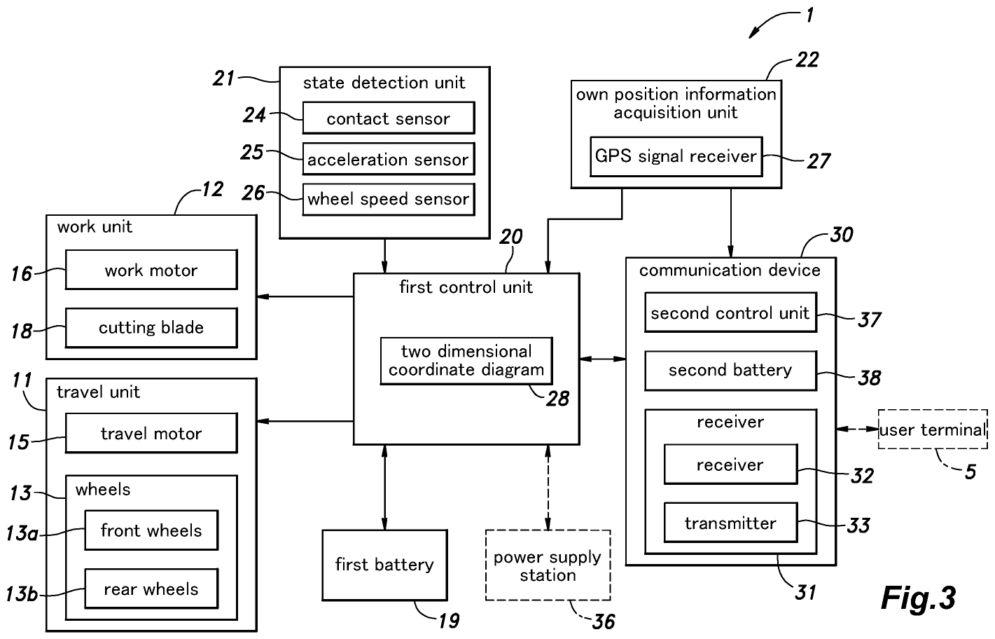

FIG. 3 is a block diagram showing the functional configuration of the lawnmower 1. As shown in FIGS. 2 and 3, the state detection unit 21 may include at least one of a contact sensor 24 that detects that the lawnmower 1 has come into contact with an obstacle, an acceleration sensor 25 that detects the acceleration of the main body 10 of the lawnmower 1, and a wheel speed sensor 26 that detects the rotational speed of the wheels 13. Based on the information acquired by the state detection unit 21, the first control unit 20 determines the operating state of the lawnmower 1. For example, the first control unit 20 detects that the lawnmower 1 is snagged by an obstacle, and has become unable to travel when the lawnmower 1 is in contact with an object for more than a predetermined time period based on the detection result of the contact sensor 24. Additionally or alternatively, the first control unit 20 detects that the lawnmower 1 fails to travel even though the travel motor 15 is being driven based on the detection result of the acceleration sensor 25 and the voltage applied to the travel motor 15. In other words, the first control unit 20 can determine the operating state of the lawnmower 1 by detecting if the rear wheels 13b, which are the drive wheels, are slipping or not. Further, the first control unit 20 can compare the rotational speeds of the left and right rear wheels 13b, which are the drive wheels, with the rotational speeds of the left and right front wheels 13a, which are the driven wheels, based on the detection result of the wheel speed sensor 26. When the rotational speed of the rear wheels 13b is higher than the rotational speeds of the front wheels 13a by more than a predetermined value, it can be determined that the rear wheels 13b (drive wheels) are slipping.

The own position information acquisition unit 22 acquires the position information of the lawnmower 1 (hereinafter referred to as own position information). The own position information is obtained based on, for example, a signal from a GPS satellite. In such a case, the position information acquisition unit 22 includes a GPS signal receiver 27 that receives a signal from the GPS satellite at a predetermined frequency (for example, several times per minute). The first control unit 20 converts the signal received by the GPS signal receiver 27 into own position information defined by latitude and longitude, and stores the position information in memory. The first control unit 20 has a two-dimensional coordinate diagram 28 so that the user can determine the position of the lawnmower 1 relative to a designated area by inputting a corresponding command from the user terminal 5 or any other suitable input means (not shown in the drawings). The first control unit 20 can send the own position information and the determination result (in particular, if the position of the lawnmower 1 is within the designated area or not) to the user terminal 5 via a communication device 30. The user can confirm the position of the lawnmower 1 based on the information transmitted to the user terminal 5.

The communication device 30 is provided with a communication unit 31 that transmits/receives information to/from the user terminal 5 via the cellular communication line 7 or the Internet 8 (see FIG. 1). The information received by the lawnmower 1 may include information about the designated area mentioned above, and the information transmitted by the lawnmower 1 may include state information regarding the operating state of the lawnmower 1. The communication unit 31 thus includes a receiver 32 for receiving information and a transmitter 33 for transmitting information.

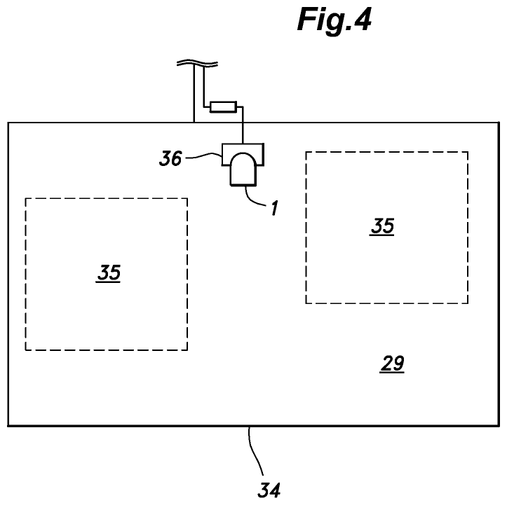

The receiver 32 receives the information regarding the designated area transmitted from the user terminal 5. The designated area may include a control area 29 and work areas 35 as shown in FIG. 4. The control area 29 may refer to an area defined by a geo-fence 34 provided as a boundary in which the lawnmower 1 is expected to be located under normal circumstances. When the lawnmower 1 leaves the control area 29, it can be judged that the lawnmower 1 is stolen or otherwise moved out of the boundary without the knowledge of the operator. The work areas 35 may refer to areas where the lawnmower 1 is expected to perform lawnmowing work. As shown in FIG. 3, the transmitter 33 transmits various pieces of information to be received by the user terminal 5, such as the state information detected by the state detection unit 21 and the own position information acquired by the own position information acquisition unit 22 and converted into coordinates by the first control unit 20, at predetermined transmission time intervals.

The communication device 30 is controlled by the first control unit 20 and is supplied with electric power from the first battery 19 or an external power supply station 36. The communication device 30 further includes a second control unit 37 capable of controlling the communication device 30, and a second battery 38 that can supply electric power to the communication unit 31 and the second control unit 37.

The second control unit 37 controls the communication device 30 and the position information acquisition unit 22 when the communication device 30 is not controlled by the first control unit 20 (such as when the first control unit 20 is not receiving any electric power). The second battery 38 supplies electric power to the communication device 30 when the communication device 30 is under the control of the second control unit 37. Upon losing the power supply from the first battery 19 to the first control unit 20, the second control unit 37 switches the power supply source from the first battery 19 to the second battery 38. In other words, the communication device 30 can maintain communication even when the first control unit 20 ceases functioning.

The first control unit 20 and the second control unit 37 are individually configured to control the operation of the lawnmower 1 in performing autonomous lawn mowing work. Upon power up, the first control unit 20 starts acquiring the state information and the own position information of the lawnmower 1. Then, the first control unit 20 instructs the communication device 30 to transmit the acquired information to the user terminal 5 at a predetermined transmission time interval. The transmission time interval (or the time interval at which information is transmitted by the transmitter 33 of the communication device 30) is determined based on the state information and own position information of the lawnmower 1. The process of determining the transmission time interval may be referred to as the transmission time interval determination process.

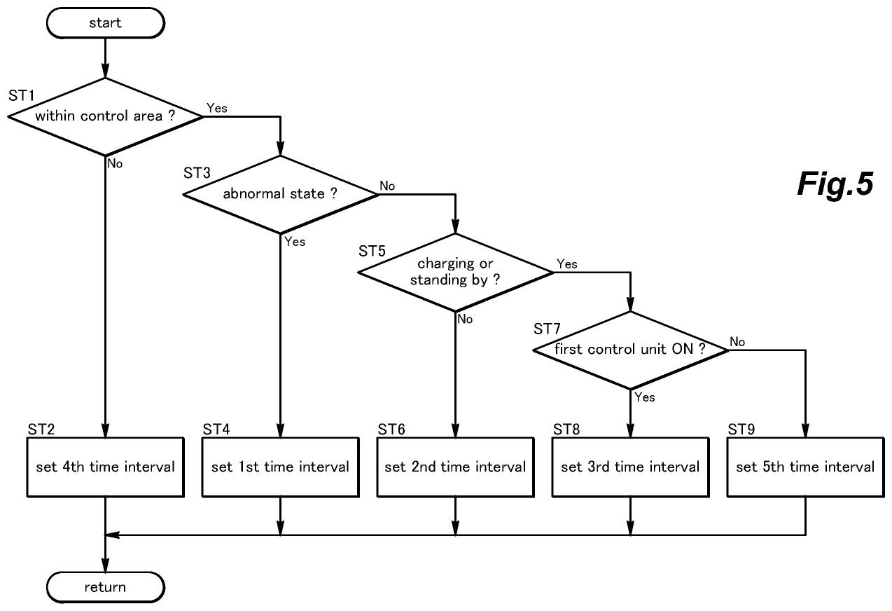

An outline of the transmission time interval determination process will be described in the following with reference to FIG. 5. First of all, the first control unit 20 determines the relationship between the position of the lawnmower 1 acquired by the own position information acquisition unit 22 and the control area 29 designated by the user to determine if the lawnmower 1 is located within the control area 29 (step ST1). More specifically, the first control unit 20 processes the signal received by the GPS signal receiver 27 to acquire the coordinates of the lawnmower 1, and compares the acquired coordinates with the coordinates of the control area 29 which are stored in advance. Thereby, it can be determined if the lawnmower 1 is located within the control area 29 or not. If the lawnmower 1 is not located in the control area 29, the transmission time interval at which information is transmitted from the transmitter 33 of the communication device 30 is set to a fourth time interval (for example, 12 minutes) (Step ST2). If the lawnmower 1 is located within the control area 29, the first control unit 20 executes step ST3.

In step ST3, the first control unit 20 determines if the lawnmower 1 is in an abnormal operating state based on the information provided by the state detection unit 21 (for example, an abnormal operating state exists when the lawnmower 1 is prevented from travelling by an obstacle, when the wheels 13 are slipping and so on). More specifically, the first control unit 20 compares the rotational speed of the front wheels 13a with the rotational speed of the rear wheels 13b based on the information obtained by the wheel speed sensor 26 to determine if the wheels 13 of the lawnmower 1 are slipping. When an abnormal operating state of the lawnmower 1 is detected, the first control unit 20 sets the transmission time interval to a first time interval (for example, 60 seconds) (step ST4). The first time interval is shorter than the fourth time interval. The first control unit 20 executes step ST5 when the operating state of the lawnmower 1 is normal.

In step ST5, the first control unit 20 determines if the lawnmower 1 is charging or waiting. More specifically, the first control unit 20 monitors the electric current supplied to the first battery 19 via the external power supply station 36. The first control unit 20 determines that the lawnmower 1 is charging when electric current is being supplied to the first battery 19. When no electric current is being supplied to the first battery 19 and the internal voltage of the first battery 19 is equal to or higher than a predetermined threshold value, it is determined that the lawnmower 1 is on standby. The predetermined threshold value is a value by which the first control unit 20 determines that the first battery 19 is fully charged. When the first control unit 20 determines that the lawnmower 1 is not charging or standing by, it sets the transmission time interval to a second time interval (for example, 120 seconds) (step ST6). The second time interval is longer than the first time interval and shorter than the fourth time interval. The first control unit 20 executes step ST7 when it is determined that the lawnmower 1 is charging or waiting.

In step ST7, the first control unit 20 determines if electric power is being supplied thereto. When the first control unit 20 is receiving electric power (or if the power is turned on), the first control unit 20 sets the transmission time interval to a third time interval (for example, 5 minutes) (step ST8) which is longer than the second time interval and shorter than the fourth time interval. When electric power is not being supplied to the first control unit 20, the second control unit 37 of the communication device 30 switches the power supply source to the second battery 38, and sets the transmission time interval to a fifth time interval (for example, 30 minutes) (Step ST9) which is longer than the fourth time interval.

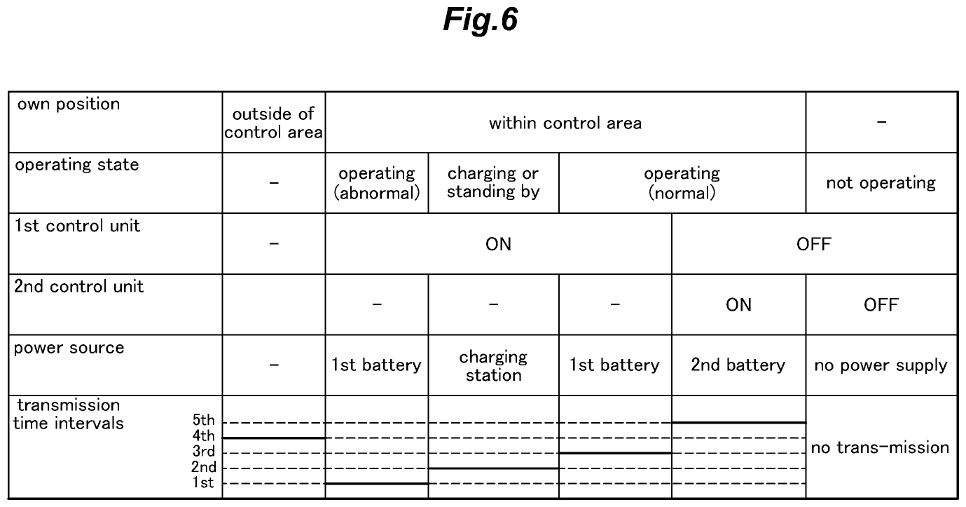

As soon as the transmission time interval is newly set to any of the first to fifth time intervals, the first control unit 20 restarts the transmission time interval determination process from step ST1. The transmission time interval determination process ends when the lawnmower 1 receives an instruction to end the transmission time interval determination process transmitted by the user terminal 5 or an input means (not shown in the drawings). The transmission time interval, which is determined by the transmission time interval determination process, is related to the operating state and the own position state of the lawnmower 1 as shown in the table of FIG. 6.

Further, although not shown in the drawings, when the first control unit 20 detects that the elapsed time period from the time point when the lawnmower 1 is determined to be in an abnormal state exceeds a predetermined time in step ST3, the first control unit 20 may stop the power supply to itself. When the supply of electric power to the first control unit 20 is stopped, the second control unit 37 takes over the control, switches the power supply source to the second battery 38, and sets the transmission time interval to the fifth time interval.

The mode of operation and various features of the lawnmower management system 3 described above will be discussed in the following. The first control unit 20 transmits state information related to the operating state of the lawnmower 1 and own position information to the user terminal 5 via the communication device 30 at a predetermined transmission time interval. As a result, the user can check the operating state and position information of the lawnmower 1 even from a remote location. Further, since the transmission time interval differs depending on the operating state and position information of the lawnmower 1, the user can easily identify the operating state and position information from the transmission time intervals.

When the lawnmower 1 is in an abnormal state, the transmission time interval is set to a first time interval shorter than the second time interval which indicates the normal state of the lawnmower 1. Therefore, the user can readily recognize the abnormal state. Further, upon elapsing of a prescribed time period from the time point at which the lawnmower 1 is determined to be in an abnormal state, the supply of electric power to the first control unit 20 is stopped. As a result, unnecessary power discharge of the first battery 19 can be avoided. When the supply of electric power to the first control unit 20 is stopped, the second control unit 37 is able to control the communication device 30 by receiving electric power supply from the second battery 38, so that the transmission can be continued by the second control unit 37. Therefore, while the own position information is continued to be transmitted to the user terminal 5, the electric power necessary for restarting the operation of the lawn mowing work can be made available when the lawnmower 1 recovers from the abnormal state.

When the lawnmower 1 is in a normal condition, the transmission time interval is set to the second time interval which is longer than the first time interval which is set when the lawnmower 1 is in an abnormal condition. Therefore, when the lawnmower 1 is in a normal state and there is little need for the user to check the operating state of the lawnmower 1, the power consumption of the first battery 19 and the communication amount can be reduced.

When the lawnmower 1 is recharging or is not operating and ready to be employed (standing by), the transmission time interval is set to the third time interval which is longer than the second time interval which is set when the lawnmower 1 is in a normal state (is such a case as when the lawnmower 1 is traveling or mowing). Therefore, when the lawnmower 1 is neither traveling nor performing mowing work, and the user has little need to confirm the position and the state of the lawnmower 1, the power consumption of the first battery 19 and the communication amount are further reduced.

When the lawnmower 1 moves out of the control area 29 without the knowledge of the user, there is a good chance that the lawnmower 1 is stolen. In such a situation, it is desirable for the lawnmower 1 to be capable of transmitting the own position information for as long a time period as possible so that the user can track the lawnmower 1. Therefore, it is desirable to reduce the consumption of the first battery 19. According to the present embodiment, when the lawnmower 1 is located outside the control area 29, the transmission time interval is set to the fourth time interval which is longer than any of the first to third time intervals that are set when the lawnmower 1 is located inside the control area 29. Thereby, the power consumption of the first battery 19 can be minimized. As a result, the lawnmower 1 can continue to transmit the own position information for a long time period as compared with the case where the lawnmower 1 is located in the control area 29. Therefore, it becomes easier for the user to track the lawnmower 1.

When the lawnmower 1 is stolen, it is likely that the lawnmower 1 is turned off (in other words, electric power is not supplied to the first control unit 20 of the lawnmower 1). Therefore, it is desirable that the lawnmower 1 is able to continue transmitting the own position information even when the power supply from the main battery (first battery 19) is stopped. In the present embodiment, when power is not supplied to the first control unit 20 of the lawnmower 1, the second control unit 37 starts controlling the communication device 30, and the power supply source is switched to the second battery 38 so that transmission of location information is continued. Therefore, even when the power of the lawnmower 1 is turned off at the time of theft or when the charge of the first battery 19 is exhausted, the transmission of the own position information can be continued. Further, at this time, the transmission time interval is set to the fifth time interval, which is longer than any of the first to fourth time periods which are set when the first control unit 20 is controlling the communication device 30. Therefore, the transmission can be continued while minimizing the power consumption of the second battery 38. Therefore, it becomes easier for the user to track the lawnmower 1.

The present invention has been described in terms of a specific embodiment, but the present invention is not limited by such an embodiment, and can be modified in various ways without departing from the scope of the present invention. For example, in the above embodiment, when the first control unit 20 has determined in the transmission time interval determination process of step ST7 that the first control unit 20 is receiving power supply from the first battery 19, the transmission time interval is set to the third time in step ST8. However, it is also possible to arrange such that when the output voltage of the first battery 19 is detected to be equal to or higher than a predetermined threshold value in step ST7, as it can be determined that the first control unit 20 is receiving power supply from the first battery 19, and the first control unit 20 sets the transmission time interval to the third time interval in step ST8.

Further, in the above embodiment, the lawnmower 1 is provided with the first battery 19 and the second battery 38, but the second battery 38 may be omitted. In this case, the lawnmower 1 is provided with a second power supply path for supplying electric power from the first battery 19 to the communication device 30 without the intervention of the first control unit 20 when the power is turned off (or when the power is not supplied to the first control unit 20 of the lawnmower 1). In such a case, it may be arranged such that upon detecting that the power supply path has been switched to the second power supply path, the second control unit 37 sets the transmission time to a fifth time interval which is longer than any of the first to fourth time intervals which are set when the first control unit 20 controls the communication device 30. As a result, the lawnmower 1 can continue to transmit information even when the power is off. Further, since the transmission time interval is set longer than that when the power is on, the communication volume and the power consumption of the first battery 19 can be reduced.

Further, in the above embodiment, in the transmission time interval determination process of step ST3, the first control unit 20 determines if the operating state of the lawnmower 1 is in an abnormal state or not based on the information detected by the state detection unit 21. However, in step ST3, the own position information acquisition unit 22 may function as the state detection unit 21 so that the first control unit 20 may detect an abnormal state when the lawnmower 1 goes out of the control area 29 previously designated by the user. Typically, the work areas 35 are located within the control area 29 which is delimited by the geo-fence 34.

Further, in the above embodiment, the work device according to the present invention consisted of a lawnmower 1. However, the work device may also be other autonomous work devices that can travel by itself to perform a predetermined work, such as a vacuum cleaning, tilling, moving snow among other possibilities.

1. A work device (1), comprising:
a work unit (12) configured to perform a prescribed work;
a travel unit (11) configured to propel the work device;
a first control unit configured to control the work unit and the travel unit;
a state detecting unit (21) configured to detect an operating state of the work unit and the travel unit; and
a communication unit (30) configured to transmit state information on the operating state of the work unit and the travel unit,
wherein the first control unit is configured to transmit state information regarding the operating state via the communication unit at a prescribed transmission time interval, the prescribed transmission time interval being varied between a first time interval, and a second time interval which is longer than the first time interval based on the operating state.

2. The work device according to claim 1, wherein the first control unit is configured to set the transmission time interval to the second time interval when the operating state is normal, and set the transmission time interval to the first time interval when the operating state is not normal.

3. The work device according to claim 2, wherein the first control unit is configured to set the transmission time interval to a third time interval which is longer than the second time interval when the work unit and the travel unit are not operating.

4. The work device according to claim 2, further comprising an own position information acquisition unit (22) for acquiring own position information, and the first control unit is configured to transmit the own position information together with the state information via the communication device.

5. The work device according to claim 4, further comprising the work device further comprises a first battery (19) for supplying electric power to the work unit and the travel unit, and a second battery (38) for supplying electric power to the communication device.

6. The work device according to claim 5, further comprising a second control unit, when the power is turned on, and the first battery has a charge greater than a prescribed threshold, the first battery supplies electric power to the first control unit and the communication device, and when the charge of the first battery has fallen below the threshold, electric power is supplied from the second battery to the second control unit so that the second control unit continues to transmit the own position information and the state information via the communication unit at a prescribed time interval.

7. The work device according to claim 6, wherein the transmission time interval for transmitting the state information via the communication device is longer when the communication device receives electric power from the second battery than when the communication device receives electric power from the first battery.

8. The work device according to claim 1, wherein when the first control unit has detected the operating state to be not normal, the first control unit ceases supply of electric power from the first battery to the first control unit upon elapsing of a prescribed time period from a time point of detecting the operating state to be not normal.

9. The work device according to claim 4, wherein the first control unit is configured to determine if the work device is located within a control area (29) designated by a user based on the own position information, and upon detecting that the work device is not located within the control area, the transmission time interval is set to a fourth time interval which is longer than the second time interval.
